(19) United States
(12) Patent Application Publication
(10) Pub. No.: US 2022/0194662 A1
(43) Pub. Date: Jun. 23, 2022

(54) REUSABLE RECYCLABLE PACKING POUCH

(71) Applicant: Federal Express Corporation, Memphis, TN (US)

(72) Inventor: Yongquan Zhou, Oakland, TN (US)

(21) Appl. No.: 17/125,611

(22) Filed: Dec. 17, 2020

(51) Int. Cl. B65D 25/34

(52) U.S. Cl. CPC B65D 25/34; B65D 2543/00296; B65D 2565/381; B65D 2543/00796; B65D 2543/00722

(57) ABSTRACT

Methods, systems, and apparatus, including a reusable recyclable packing pouch are described. The reusable recyclable packing pouch includes a plastic container, a paperboard jacket, and an adhesive coating. The plastic container includes a first portion and a second portion. The first portion has a shaped region with a flange extending around a perimeter of the shaped region. The second portion is sized to mate with the flange such as to define a space between facing surfaces of the second portion and the shaped region of the first portion. The paperboard jacket comprising an aperture defined therethrough. The aperture is sized to permit the shaped region of the plastic container to pass through while the flange extends past edges of aperture and overlaps with a region of paperboard jacket at a periphery of the aperture. The adhesive coating located on a surface of the paperboard jacket.

### BACKGROUND

Packing pouches can be employed in logistics transportation and package shipment as an instrument to contain shipping documents, tracking devices, and monitoring devices. The pouch is attached to a package as the package travels through a distribution channel. Packing pouches are commonly broken open when removing shipping documents, tracking devices, and monitoring devices from a package after use, and are generally not reusable nor recyclable.

### SUMMARY

This specification relates to reusable recyclable packing pouches. Implementations of the present disclosure relate to a reusable recyclable packing pouch. The reusable recyclable packing pouch includes a plastic container, a paperboard jacket, and an adhesive coating. The plastic container includes a first portion and a second portion. The first portion has a shaped region with a flange extending around a perimeter of the shaped region. The second portion is sized to mate with the flange such as to define a space between facing surfaces of the second portion and the shaped region of the first portion. The paperboard jacket includes an aperture defined therethrough. The aperture is sized to permit the shaped region of the plastic container to pass through while the flange extends past edges of aperture and overlaps with a region of paperboard jacket at a periphery of the aperture. The adhesive coating located on a surface of the paperboard jacket.

In some implementations, the plastic container can include a transparent portion. The transparent portion can permit scanning of a machine readable code contained within the plastic container. The machine readable code can contain information regarding a content of the reusable recyclable packing pouch.

In some implementations, the reusable recyclable packing pouch includes a monitoring device to sense a condition of a package to which the reusable recyclable packing pouch is attached. The condition of the package can be one or more of: a location of the package, an orientation of the package, or a handling history of the package.

In some implementations, the paperboard jacket has perforations extending from the edge of the aperture to an outer edge of the paperboard jacket.

In some implementations, the shaped region is sized to contain shipping documents. The shaped region can accommodate a tracking sensor within the space defined between the facing surfaces of the of the second portion and the shaped region of the first portion.

In some implementations, the adhesive coating is located within a second region of the paperboard jacket that does not overlap with the region of paperboard jacket at a periphery of the aperture.

In some implementations, the plastic container is polyethylene terephthalate.

In some implementations, the plastic container is constructed from a recyclable material.

Further implementations of the present disclosure include a shipping container with a reusable recyclable packing pouch. The shipping container includes a plastic container and a paperboard jacket. The plastic container is positioned on a surface of the shipping container. The plastic container includes a first portion and a second portion. The first portion has a shaped region with a flange extending around a perimeter of the shaped region. The second portion is mated with the flange to define a space between facing surfaces of the second portion and the shaped region of the first portion. The paperboard jacket adheres to the surface of the shipping container, The paperboard jacket includes an aperture defined therethrough. The shaped region of the plastic container extends through the aperture while the paperboard jacket overlaps the flange of the plastic container so as to retain the plastic container in place on the surface of the shipping container. In some implementations, the plastic container further comprises a transparent portion.

Further implementations of the present disclosure include a method of making a reusable recyclable packing pouch. The method includes forming a plastic piece to form a plastic container. The plastic container includes a first portion and a second portion. The first portion has a shaped region with a flange extending around a perimeter of the shaped region. The second portion is sized to mate with the flange such as to define a space between facing surfaces of the second portion and the shaped region of the first portion. The plastic piece can be thermally pressing to form the plastic container. The shaped region can be formed to accommodate a monitoring sensor within the space defined between the facing surfaces of the second portion and the shaped region of the first portion.

The method includes forming a paperboard jacket. The paperboard jacket includes an aperture defined therethrough. The aperture is sized to permit the shaped region of the plastic container to pass through while the flange extends past edges of aperture and overlaps with a region of paperboard jacket at a periphery of the aperture. An adhesive coating can be applied on a surface of the paperboard jacket. The paperboard jacket can be sealed shut by the adhesive coating. A front surface of the paperboard jacket can be perforated. Perforating the front surface of the paperboard jacket can form the front surface of the paperboard jacket to be torn to open the paperboard jacket and remove contents. A transparent window can be fixed to the paperboard jacket to allow a visual sensor to sense a condition within the paperboard jacket on the paperboard jacket. A release liner can be attached to an exterior surface of a back sheet via the adhesive coating such that the release liner is removable.

Particular implementations of the subject matter described in this specification can be implemented so as to realize one or more of the following advantages. Implementations provide a packing pouch with reusable components. For example, implementations reduce single use plastic components in shipping pouches, and thus, reduce plastic waste entering the environment. Recycling efficiency may be improved by easily separating independently recyclable materials. Implementations may improve shipping monitoring device longevity by providing a durable protective casing. Implementations may improve shipping within a distribution channel for sending and receiving shipments by improving the likelihood that shipping documents are kept with corresponding shipments throughout the journey through the channel. Implementations may reduce the lost or missing of shipments within a distribution channel.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a front view of an example reusable recyclable packing pouch affixed to a shipping package.

FIG. 2A is a top view of an example plastic container of the reusable recyclable packing pouch of FIG. 1.

FIG. 2B is a cross-section view of the plastic container of FIG. 2A with the plastic container open along cross section A-A.

FIG. 2C is a cross-section view of the plastic container of FIG. 2A with the plastic container partially shut.

FIG. 2D is a cross-section view of the plastic container of FIG. 2A with the plastic container fully shut.

FIG. 3A is a cross-section view of a first alternative embodiment of the plastic container with the plastic container partially open.

FIG. 3B is a cross-section view of the first alternative embodiment of the plastic container of FIG. 3A with the plastic container fully shut.

FIG. 4A is a cross-section view of a second alternative embodiment of the plastic container with the plastic container partially open.

FIG. 4B is a cross-section view of the second alternative embodiment of the plastic container of FIG. 4A with the plastic container fully shut.

FIG. 5A is a top view of a third alternative plastic container of the reusable recyclable packing pouch of FIG. 1.

FIG. 5B is a cross-section view of the third alternative plastic container of FIG. 5A with the plastic container open along cross section B-B.

FIG. 5C is a cross-section view of the third alternative plastic container of FIG. 5A with the plastic container open along cross section C-C.

FIG. 5D is a cross-section view of the third alternative plastic container of FIG. 5A with the plastic container open along cross section D-D.

FIG. 6A is a front view of an example paperboard jacket assembly of the reusable recyclable packing pouch of FIG. 1.

FIG. 6B is a side view of the paperboard jacket assembly of the reusable recyclable packing pouch of FIG. 6A.

FIG. 7A is a back view of a first alternative paperboard jacket assembly of the reusable recyclable packing pouch of FIG. 1.

FIG. 7B is a cross-section view of the first alternative paperboard jacket assembly of the reusable recyclable packing pouch of FIG. 7A.

FIG. 8A is a top perspective view of the front side reusable recyclable packing pouch of FIG. 1.

FIG. 8B is a perspective view of the back side of the reusable recyclable packing pouch of FIG. 1.

FIGS. 9A-H illustrate steps of a method of assembling the reusable recyclable packing pouch of FIG. 1.

FIG. 10A is a top view of another example of the reusable recyclable packing pouch.

FIG. 10B is a cross-section view of the recyclable packing pouch of FIG. 10A with the recyclable packing pouch open along cross section E-E.

FIGS. 11A-H illustrate steps of a method of assembling the reusable recyclable packing pouch of FIG. 10A.

FIG. 12A is a top view of another reusable recyclable packing pouch for attaching to a rope.

FIG. 12B is a cross-section view of the recyclable packing pouch of FIG. 12A with the recyclable packing pouch open along cross section F-F.

FIGS. 13A-E illustrate steps of a method of assembling the recyclable packing pouch of FIG. 12A.

FIG. 14 is an example method of manufacturing the reusable recyclable packing pouch.

Like reference numbers and designations in the various drawings indicate like elements.

### DETAILED DESCRIPTION

A distribution channel for sending and receiving shipments generally employs shipping documents to route, sort, and track various shipments flowing through the channel. Shipping documents include, for example, air waybills, shipping labels, invoices, packing lists, and other paperwork related to a shipment. The shipping documents are placed inside a pouch that is attached to a receiving surface such as a package, box, carton, or other container to be shipped through the channel. To insure proper sorting, tracking, import/export, and ultimately, delivery, it is important to keep shipping documents with the shipment throughout the journey through the channel. At the destination, the recipient breaks opens the pouch and removes the shipping documents.

The shipping documents can include items such as packing slips or monitoring devices. Monitoring devices can be larger or shaped such as to require additional protection while enclosed in the pouch. Package monitoring devices that can be placed in a packing pouch include, but are not limited to, devices which monitor location, temperature, humidity, atmospheric pressure, tilt angle, shock, or vibration.

While most shipping packages are made of recyclable corrugated boards, the traditional adhesive plastic pouches and packing list envelopes make recycling shipping packages difficult and costly. The plastic packing pouches and envelopes must be removed before the cardboard board package can be recycle. However, traditional packing pouches and envelopes often stretch, tear, and rarely come off the package in one piece. If not recycled, those plastic pouches and packing list envelopes may be sent to land-fills directly, end up at land-fills, or are dumped into the ocean where they remain and do not be decomposed, polluting the land or ocean. Additionally, these plastic materials may contaminate water and/or injure fish or other marine animals.

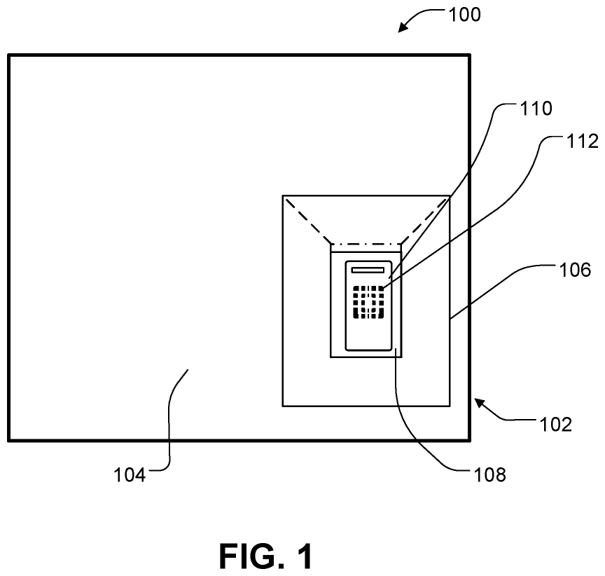

FIG. 1 illustrates an exemplary reusable recyclable packing pouch 102 attached to a shipping package 104. The packing pouch 102 includes a plastic container 108, a paperboard jacket 106 with an adhesive coating attaching the paperboard jacket 106 to the shipping package 104. The plastic container 108 includes a first portion and a second portion. The first portion has a shaped region having a flange extending around a perimeter of the shaped region. The second portion is sized to mate with the flange such as to define a space between facing surfaces of the second portion and the shaped region of the first portion. The paperboard jacket 106 has an aperture defined there through. The aperture is sized to permit the shaped region of the plastic container to pass through while the flange extends past edges of aperture and overlaps with a region of paperboard jacket 106 at a periphery of the aperture. The adhesive coating is located on a backside surface of the paperboard jacket 106.

As shown in FIG. 1, a prepared shipping package 104 is ready for shipping. The recyclable shipping pouch 102 is affixed to an outside surface of the cardboard shipping package 104. The paperboard jacket 106 holds the plastic container 108 to the shipping package 104. In the illustrated example, the plastic container contains a monitoring device 110.

The shipping package 104 is one example of a shipping container to which the recyclable shipping pouch 102 can be affixed. For example, the recyclable shipping pouch 102 can be affixed to a cardboard box, a thin paper envelope, a plastic envelope, a unit load device (ULD), a cargo net, a pallet, or a reusable returnable shipping container.

The monitoring device 110 senses a condition or multiple conditions of the shipping container. For example, the monitoring device 110 can track and monitor location, temperature, humidity, atmospheric pressure, tilt angle, shock, or vibration. The monitoring device 110 can include an electronic log or electronic receiver to sense electronic signals. For example, the monitoring device 110 can include an electronic receiver to receive satellite signals to determine the shipping container location. The monitoring device 110 can include an electronic transmitter to transmit shipping container conditions or location. The monitoring device 110 can include machine readable code 112 which contains information regarding a content of the reusable recyclable packing pouch 102 or the shipping package 104.

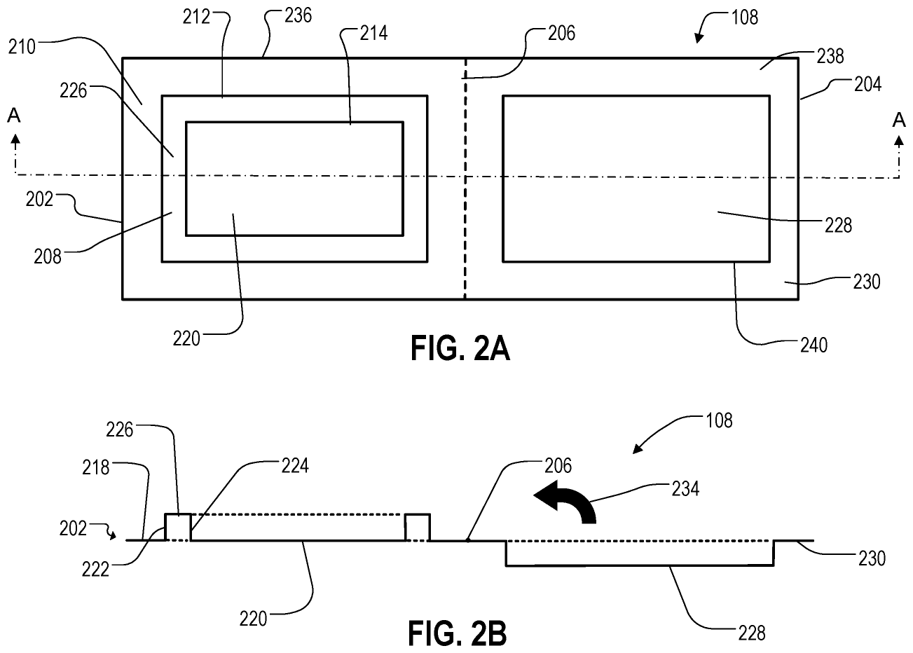

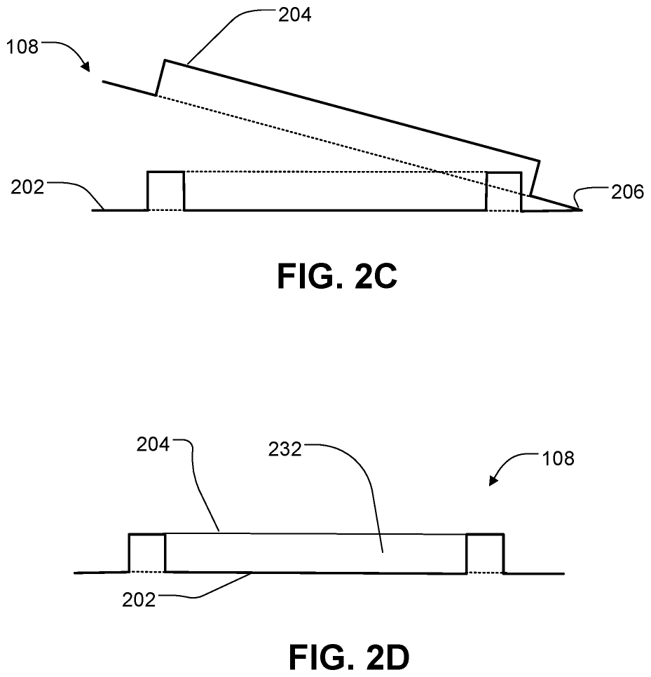

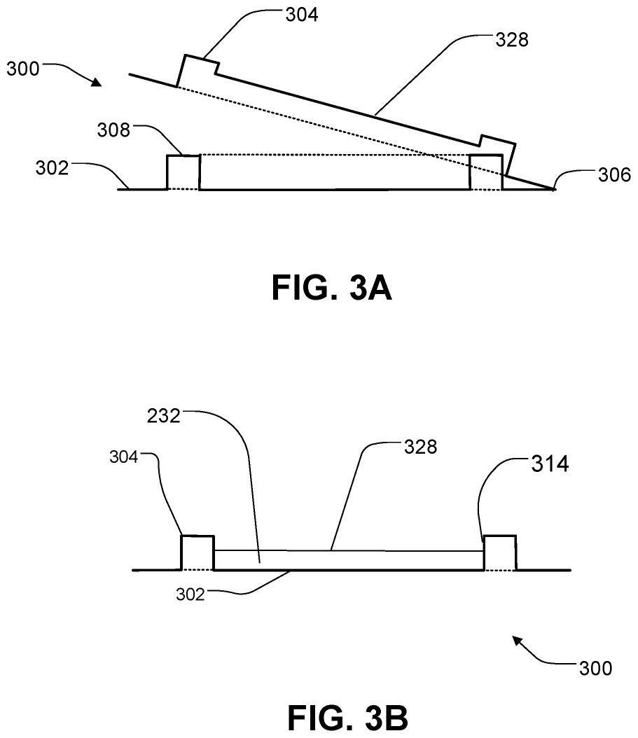

Referring to FIG. 2A-2D, the plastic container 108 has a first portion 202 and a second portion 204. The first portion has a first shaped region 208. The first shaped region 208 can be rectangular, as shown in FIG. 2A. Alternatively, the first shaped region 208 can be a different geometric shape. For example, the first shaped region can be a square, a circle, a triangle, a hexagon, or irregular. In other words, the first and second portions 202, 204 can be shaped/sized to suit a desired purpose, e.g., to contain various types of monitoring devices or shipping documents. For example, as discussed in more detail below, FIGS. 3A-3B, 4A-4B, and 5A-5D show various alternate cross-sectional shapes for the plastic container 108. The first shaped region 208 has a first flange 210 that extends around a first perimeter 212 of the first shaped region 208. The first perimeter 212 and a second perimeter 214 define the first shaped region 208. The first shaped region 208 has a top surface 226 different that the first surface 218. The top surface 218 and the first perimeter 212, and the second perimeter 214 define the first shaped region 208.

FIG. 2B shows a cross section of the plastic container 108 along cross section A-A. Referring to FIG. 2B, the first flange 210 extends from the first perimeter 212 to an outer perimeter 236 of the plastic container 108. The first shaped region 208 has a first recessed region 220 defined by the second perimeter 214. The greater height of either an outer surface 222 or an inner surface 224 of the first flange 210 defines the height of the first shaped region 220. The outer surface 222 and the inner surface 224 are connected by the top surface 226. The inner surface 224 extends around the second perimeter 214 to define a first recessed region 220. The first recessed region 220 is sized to hold the monitoring device 110 and/or a packing slip.

The plastic container 108 has a second portion 204 sized to mate with the first shaped region 208. The second portion 204 has a second recessed region 228 extending from a second surface 230 at a third perimeter 240 such as to define a void 232. The void 232 can also be referred to as a space. The void 232 is between facing surfaces: the first surface 218 of the first portion 202 and the second surface 230 of the second portion 204. The second portion 204 has a second flange 238 corresponding to the second surface 230. The first portion 202 and the second portion 204 are placed together by mating the first flange 210 and the second flange 238 to form the void 232. The void 232 holds the monitoring device 110. The first portion 202 and the second portion 204 snap together to form the protective shell. A hinge 206 can connect the first portion 202 and the second portion 204. For example, when the first portion 202 and the second portion 204 are formed from a single piece of plastic, the hinge 206 can be a weaker portion of the plastic allowing the first portion 202 and the second portion 204 to articulate about the hinge 206. For example, the hinge 206 can be a thinner portion of plastic as compared to the first portion 202 and the second portion 204. Alternatively, hinge 206 can be a perforated portion of plastic between the first portion 202 and the second portion 204. Referring to FIG. 2B, the first portion 202 and the second portion 204 articulate about the hinge 206 like a clam-shell in the direction of arrow 234. Referring to FIG. 2C, the second portion 204 closes onto the first portion 202. Referring to FIG. 2D, the second portion 204 fully closes to snap onto the first portion 202. Alternatively, the first portion 202 and the second portion 204 can be separate pieces. For example, the second portion 204 can be situated to close onto the first portion 202, then forced together to snap shut.

The plastic container 108 can include a transparent portion. The transparent portion allows transmission of light into the plastic container 108 and a person or machine to view and scan the contents (the monitoring device 110 and/or the packing slip). The transparent portion permits scanning of a machine readable code 112 (as shown in FIG. 1) on the monitoring device 110 and/or the packing slip contained within the plastic container 108. For example, the machine readable code can be a quick response (QR) code consisting of a matrixed black and white squares and read by a QR code scanner (not shown). The QR code can contain information regarding a content of the reusable recyclable packing pouch. In some cases, the entire plastic container 108 is transparent. Additionally, the condition of the shipping envelope as shown by the monitoring device 110 described above can be observed by the person.

The plastic container 108 is constructed from a plastic material. For example, the plastic container 108 can be polyethylene terephthalate, polyethylene, or polypropylene. The plastic container 108 is constructed from a recyclable material. The plastic material of the plastic container provides protection to the contents of the plastic container 108 from scuffing, shock/vibration and compression from all directions and protection to the machine readable code 112 on the monitoring device 110.

Referring to FIGS. 3A and 3B, a plastic container 300 generally similar to the plastic container 108 is shown. The plastic container 300 has a first portion 302 substantially similar to the first portion 202 discussed earlier. The plastic container 300 has a second portion 304 generally similar to the second portion 204 discussed earlier. The second portion 304 has a partially recessed region 328 similar to the second recessed region 228. The partially recessed region 328 spans the area corresponding to the similar area of the first shaped region 208 inside the second perimeter 214 shown in FIG. 2A. The plastic container 300 includes a hinge 306 coupling the first portion 302 and the second portion 304.

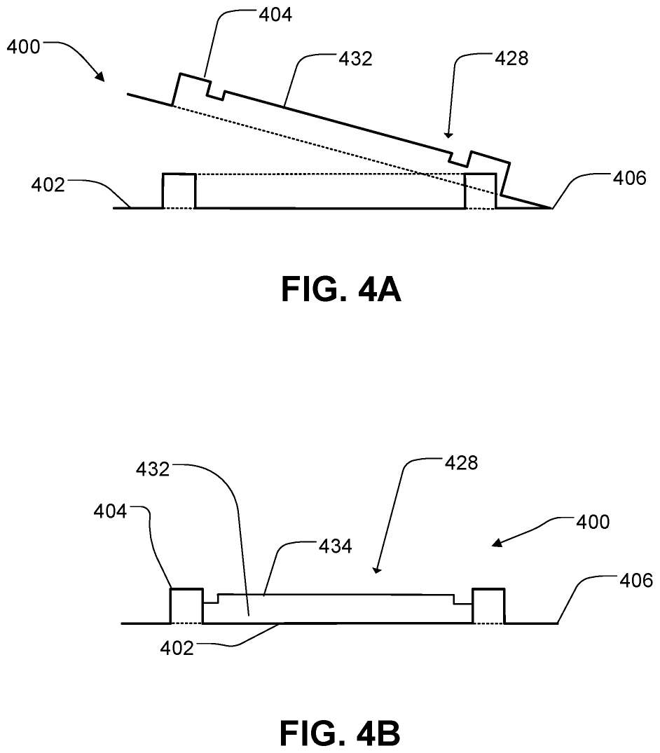

Referring to FIGS. 4A and 4B, a plastic container 400 generally similar to the plastic container 300 is shown. The plastic container 400 has a first portion 402 substantially similar to the first portion 202 discussed earlier. The plastic container 400 has a second portion 404 generally similar to the second portion 204 discussed earlier. The second portion 404 has a partially recessed region 428 similar to the second recessed region 328. The partially recessed region 428 spans a portion of the area similar to the area of the first shaped region 208 inside the second perimeter 214 shown in FIG. 2A. The partially recessed region 428 can appear as a bulge 434 in the second portion 404. The plastic container 400 includes a hinge 406 coupling the first portion 402 and the second portion 404. When the second portion 404 is shut on the first portion 402, a void 432 is defined in the space between the second portion 404 and the first portion 402.

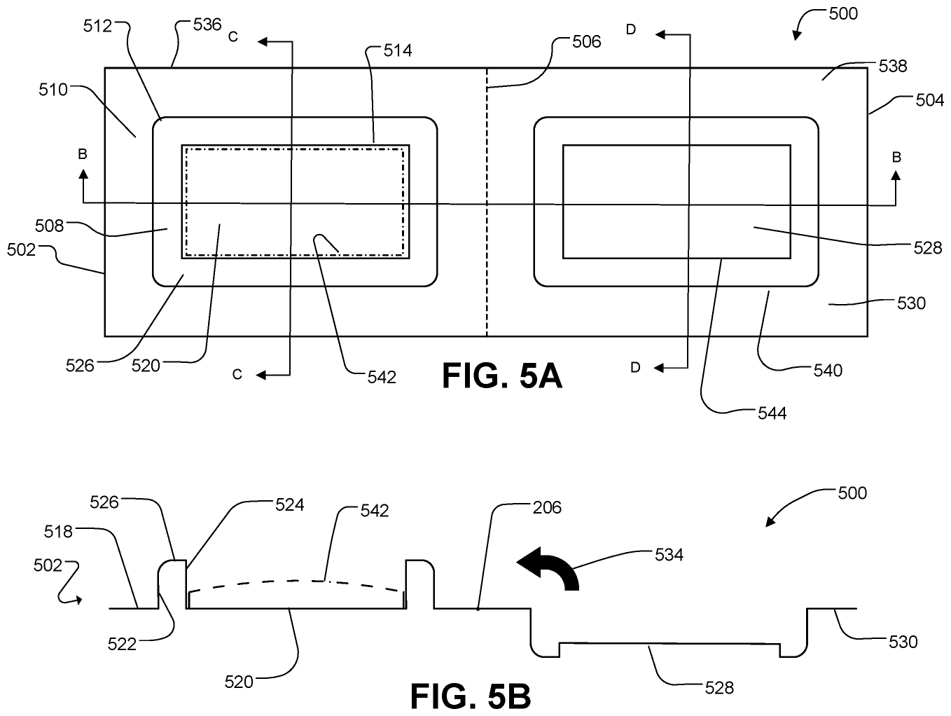

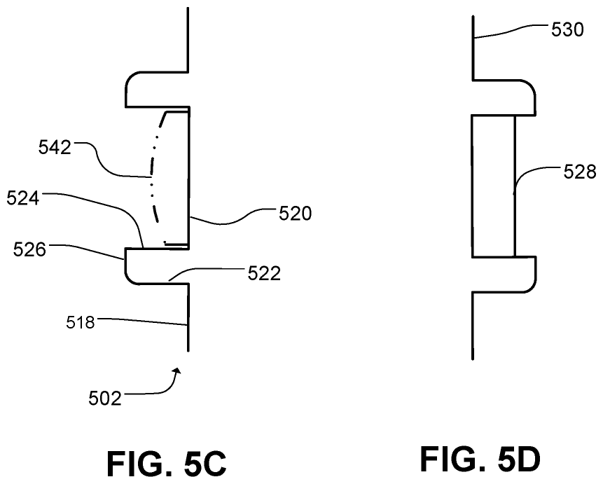

FIG. 5A is a top view of a third alternative plastic container 500 of the reusable recyclable packing pouch of FIG. 1. Referring to FIG. 5A-5D, the third alterative plastic container 500 has a first portion 502 and a second portion 504. The first portion has a first shaped region 508. The first shaped region 508 can be rectangular, as shown in FIG. 5A. Alternatively, the first shaped region 508 can be a different geometric shape. For example, the first shaped region can be a square, a circle, a triangle, a hexagon, or irregular. In other words, the first and second portions 502, 504 can be shaped/sized to suit a desired purpose, e.g., to contain various types of monitoring devices or shipping documents. The first shaped region 508 has a first flange 510 that extends around a first perimeter 512 of the first shaped region 508. The first perimeter 512 and a second perimeter 514 define the first shaped region 508. The first shaped region 508 has a top surface 526 different that the first surface 518. The top surface 518 and the first perimeter 512, and the second perimeter 514 define the first shaped region 508. The first recessed region 520 includes and is sized to contain a resealable pouch 542. The resealable pouch 542 provides an additional barrier of protection for shipping documents or the monitoring device 110.

FIG. 5B shows a cross section of the third alternative plastic container 500 along cross section A-A. FIG. 5C is a cross-section view of the third alternative plastic container of FIG. 5A with the plastic container open along cross section C-C. FIG. 5D is a cross-section view of the third alternative plastic container of FIG. 5A with the plastic container open along cross section D-D. Referring to FIGS. 5B, 5C and 5D, the first flange 510 extends from the first perimeter 512 to an outer perimeter 536 of the plastic container 500. The first shaped region 508 has a first recessed region 520 defined by the second perimeter 514. The greater height of either an outer surface 522 or an inner surface 524 of the first flange 510 defines the height of the first shaped region 520. The outer surface 522 and the inner surface 524 are connected by the top surface 526. The inner surface 524 extends around the second perimeter 514 to define a first recessed region 520. The first recessed region 520 is sized to hold the monitoring device 110 and/or a packing slip.

The plastic container 500 has a second portion 504 sized to mate with the first shaped region 508. The second portion 504 has a second recessed region 528 extending from a second surface 530 at a third perimeter 540 such as to define a void 532. The second recessed region 528 can be further defined by a fourth perimeter 544, to make the second recessed region 528 partially recessed, as shown in FIG. 5B, and generally similar to the partially recessed plastic container 300. The void 532 can also be referred to as a space. The void 532 is between facing surfaces: the first surface 518 of the first portion 502 and the second surface 530 of the second portion 504. The second portion 504 has a second flange 538 corresponding to the second surface 530. The first portion 502 and the second portion 504 are placed together by mating the first flange 510 and the second flange 538 to form the void 532. The void 532 holds the monitoring device 110. The first portion 502 and the second portion 504 snap together to form the protective shell.

A hinge 506 can connect the first portion 502 and the second portion 504. For example, when the first portion 502 and the second portion 504 are formed from a single piece of plastic, the hinge 506 can be a weaker portion of the plastic allowing the first portion 502 and the second portion 504 to articulate about the hinge 506. For example, the hinge 506 can be a thinner portion of plastic as compared to the first portion 502 and the second portion 504. Alternatively, hinge 506 can be a perforated portion of plastic between the first portion 502 and the second portion 504. Referring to FIG. 5B, the first portion 502 and the second portion 504 articulate about the hinge 506 like a clam-shell in the direction of arrow 534.

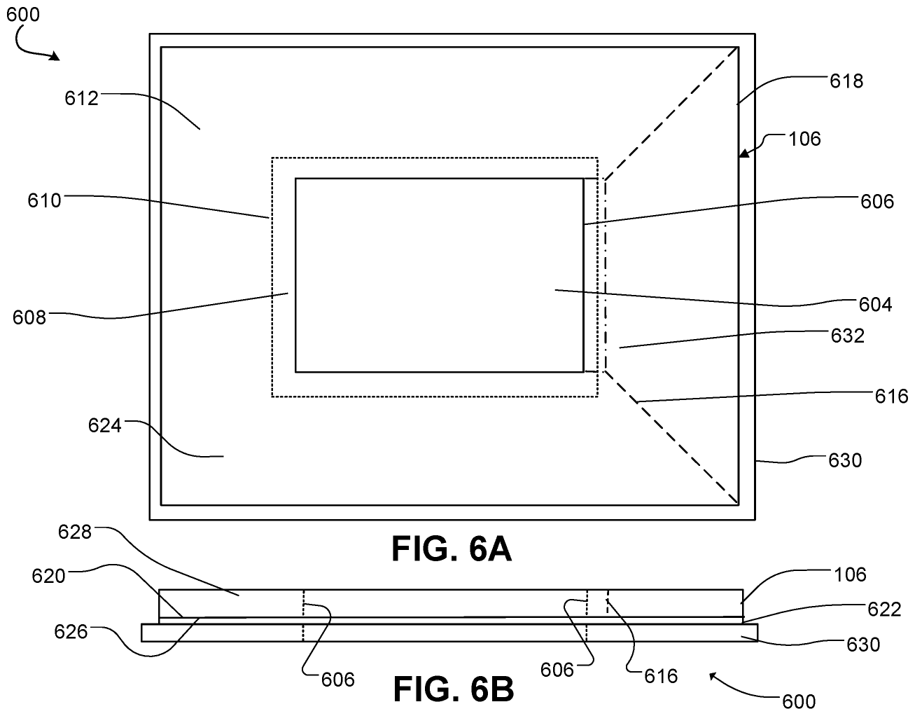

FIG. 6A is a front view of an example paperboard jacket assembly of the reusable recyclable packing pouch of FIG. 1. As shown in FIG. 6A, the reusable recyclable packing pouch 102 includes a paperboard jacket assembly 600. The paperboard jacket assembly 600 includes the paperboard jacket 106. The paperboard jacket 106 has an aperture 604 defined by a perimeter 606. The aperture 604 is sized to permit the first shaped region 208 and the second recessed region 228 of the plastic container 108 to pass through while the first flange 210 and the second flange 238, when coupled together, extend past perimeter 606 of the aperture 604. Additionally, the aperture 604 is sized to overlap with the plastic container 108 in an overlap region 608 defined by an overlap perimeter 610. The overlap region 608 of paperboard jacket 106 is at a periphery of the aperture 604 between the aperture perimeter 606 and the overlap perimeter 610. The overlap of the first flange 210 coupled to the second flange 238 in the overlap region 608 holds the plastic container 108 within the paperboard jacket 106.

The paperboard jacket 106 can be made from paper, cardboard, or similar materials. Alternatively, the paperboard jacket 106 can be made from plastics or laminates. The paperboard jacket 106 can be made from a combination of multiple materials such both paper and plastics.

The paperboard jacket 106 has a first surface 612. The first surface 612, when the paperboard jacket assembly is affixed to the shipping package 104, is away from the package and toward the person. The paperboard jacket 600 also has a second surface 614. The second surface 614, when the paperboard jacket assembly 600 is affixed to the shipping package 104, is toward the package and away from the person.

The paperboard jacket 106 has perforations 616 extending from the perimeter 606 of the aperture 604 to an outer edge 618 of the paperboard jacket 106. The perforations 616 permit tearing and opening of the paperboard jacket 106 to remove the plastic container 108 at the termination of shipping. The perforations 616 can extend from the first surface 612 to the second surface 620, shown in FIG. 6B. FIG. 6B is a side view of the paperboard jacket assembly of the reusable recyclable packing pouch of FIG. 6A. Alternatively, the perforations 616 may not necessarily extend entirely from the first surface 612 to the second surface 620. This can be referred to as scoring. The perforations 616 and a portion of the edge 618 define a perforated tab section 632. The perforations 616 can be torn to remove the perforated tab section 632, exposing the contents of the paperboard jacket assembly 600. Other easy open/tear features can be included in the paperboard jacket for easy opening.

An adhesive coating 622 is located on the second surface 620 of the paperboard jacket. The adhesive coating 622 is located within a second region 624 of the paperboard jacket that does not overlap with the overlap region 608 of paperboard jacket 106 at a periphery of the aperture 604. The second region 624 is the adhesive region. The adhesive coating 622 affixes the paperboard jacket 106 to the shipping package 104. The adhesive coating 622 can include acrylic adhesives. The adhesive coating 622 can be a permanent adhesive. The permanent adhesive is an adhesive coating 622 that once the bond of the permanent adhesive is broken, the adhesive no longer functions as an adhesive (i.e., a permanent adhesive is not resealable). Moreover, bond strength of a permanent adhesive is typically much higher than that of a resealable adhesive. For example, the bonding strength of a permanent adhesive is much higher than the force required to open the resealable adhesive without failing, separating, or peeling. The adhesive coating 622 has enough adhesion strength to survive the roughness of the shipping environment in order to prevent the paperboard jacket 106 from rubbed open and/or ripping off. The adhesive coating 622 has a first surface 626. The first surface 626 is coupled to the paperboard jacket 106. The adhesive coating 622 also has a second surface 628. The adhesive coating 622 can be a double-sided adhesive tape (i.e., a plastic strip/carrier) with a permanent adhesive.

The paperboard jacket assembly 600 includes a release liner 630. The release liner 630 is attached to the second surface 628 of the adhesive coating 622. The release liner 630 can be formed of a paper material coated with a release agent such as silicone. The release liner 630 would be removed before affixing the reusable recyclable packing pouch 100 to shipping package 104 via the exposed adhesive coating 622. The release liner 630 is attached to the exterior surface of paperboard jacket 106 to cover and protect the adhesive coating 622 until reusable recyclable packing pouch 100 is ready to be attached to the shipping package 104.

The paperboard jacket assembly 600 can include a transparent plastic sheet (not shown) affixed to the second surface 620 of the paperboard jacket 106 in the overlap region 608. The transparent plastic sheet covers the aperture 604. The transparent plastic sheet allows transmission of light into the paperboard jacket 106 and a person or machine to view and scan the contents (the monitoring device 110 and/or the packing slip). The transparent plastic sheet can be used if a packing slip is to be used, or if the monitoring device 110 is sufficiently thin or additional protection is not required.

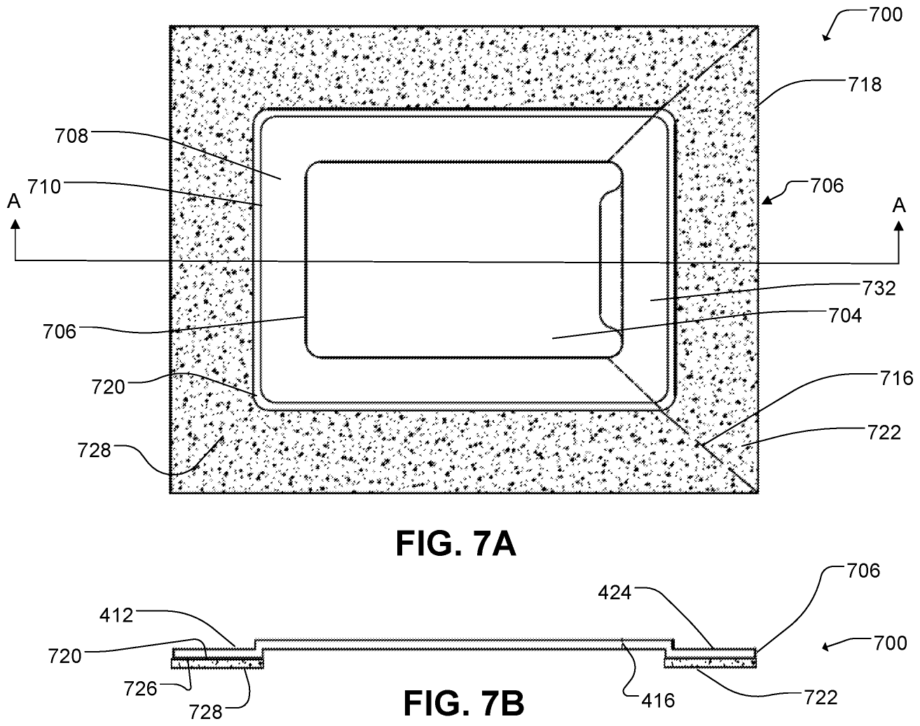

FIG. 7A is a back view of a first alternative paperboard jacket assembly of the paperboard jacket 108. As shown in FIG. 7A, the reusable recyclable packing pouch 102 includes a first alternative paperboard jacket assembly 700. The first alternative paperboard jacket assembly 700 includes the paperboard jacket 706. The paperboard jacket 706 has an aperture 704 defined by a perimeter 706. The aperture 704 is sized to permit the first shaped region 508 and the second recessed region 528 of the third alternative plastic container 500 to pass through while the first flange 510 and the second flange 538, when coupled together, extend past perimeter 706 of the aperture 704. Additionally, the aperture 704 is sized to overlap with the third alternative plastic container 500 in an overlap region 708 defined by an overlap perimeter 710. The overlap region 708 of first alternative paperboard jacket assembly 700 is at a periphery of the aperture 704 between the aperture perimeter 706 and the overlap perimeter 710. The overlap of the first flange 510 coupled to the second flange 538 in the overlap region 708 holds the third alternative plastic container 800 within the first alternative paperboard jacket assembly 700.

The paperboard jacket 706 has a first surface 712, shown in FIG. 7B. The first surface, when the first alternative paperboard jacket 700 is affixed to the shipping package 104, is away from the shipping package 104 and toward the person. The paperboard jacket 706 also has a second surface 720. The second surface 614, when the first alternative paperboard jacket assembly 700 is affixed to the shipping package 104, is toward the shipping package 104 and away from the person.

The paperboard jacket 706 has perforations 716 extending from the perimeter 706 of the aperture 704 to an outer edge 718 of the paperboard jacket 706. The perforations 716 permit tearing and opening of the paperboard jacket 706 to remove the plastic container 500 at the termination of shipping. The perforations 716 can extend from the first surface 712 to the second surface 720, shown in FIG. 7B. FIG. 7B is a cross-section view of the first alternative paperboard jacket assembly 700 of the reusable recyclable packing pouch of FIG. 6A. Alternatively, the perforations 716 may not necessarily extend entirely from the first surface 712 to the second surface 720. This can be referred to as scoring. The perforations 716 and a portion of the edge 718 define a perforated tab section 732. The perforations 716 can be torn to remove the perforated tab section 732, exposing the contents of the first alternative paperboard jacket assembly 700. Other easy open/tear features can be included in the paperboard jacket for easy opening.

An adhesive coating 722 is located on the second surface 720 of the paperboard jacket 706. The adhesive coating 722 is located within a second region 724 of the paperboard jacket 706 that does not overlap with the overlap region 708 of paperboard jacket 706 at a periphery of the aperture 704. The second region 724 is the adhesive region. The adhesive coating 722 affixes the paperboard jacket 706 to the shipping package 104. The adhesive coating 722 cis substantially similar to the adhesive coating 622 previously discussed. The adhesive coating 722 has a first surface 726. The first surface 726 is coupled to the paperboard jacket 706. The adhesive coating 722 also has a second surface 728.

The first alternative paperboard jacket assembly 700 includes a release liner, not shown, substantially similar to the release liner 630. The release liner is attached to the second surface 728 of the adhesive coating 722. The release liner 730 would be removed before affixing the reusable recyclable packing pouch 100 to shipping package 104 via the exposed adhesive coating 722. The release liner 730 is attached to the exterior surface of first alternative paperboard jacket 700 to cover and protect the adhesive coating 722 until reusable recyclable packing pouch 100 is ready to be attached to the shipping package 104.

The first alternative paperboard jacket assembly 700 can include a transparent plastic sheet (not shown) affixed to the second surface 720 of the paperboard jacket 706 in the overlap region 708. The transparent plastic sheet covers the aperture 704. The transparent plastic sheet allows transmission of light into the first alternative paperboard jacket 700 and a person or machine to view and scan the contents (the monitoring device 110 and/or the packing slip). The transparent plastic sheet can be used if a packing slip is to be used, or if the monitoring device 110 is sufficiently thin or additional protection is not required.

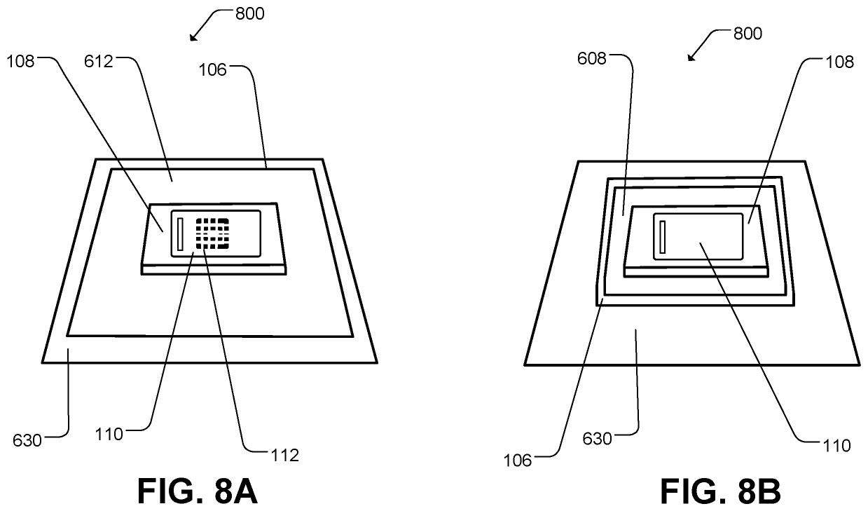

As shown in FIG. 8A, a monitoring device 110 with a QR code is positioned within the void 232 of the snapped shut plastic container 108. The plastic container 108 is positioned within the paperboard jacket 106. The first surface 612 of the paperboard jacket 106 is shown above the release liner 630. The plastic container 108 fits and is held within the overlap region 608 (as shown in FIG. 8B) of the paperboard jacket 106. The first portion 202 of the plastic container 108 is seen in FIG. 8A. The second portion 204 of the plastic container 108 is seen in FIG. 8B.

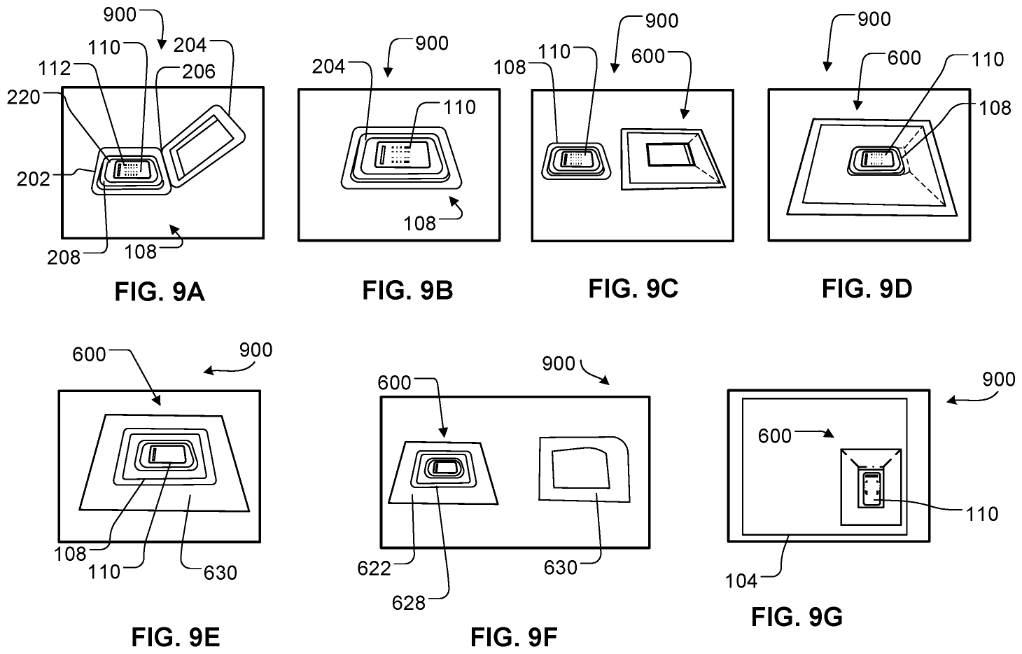

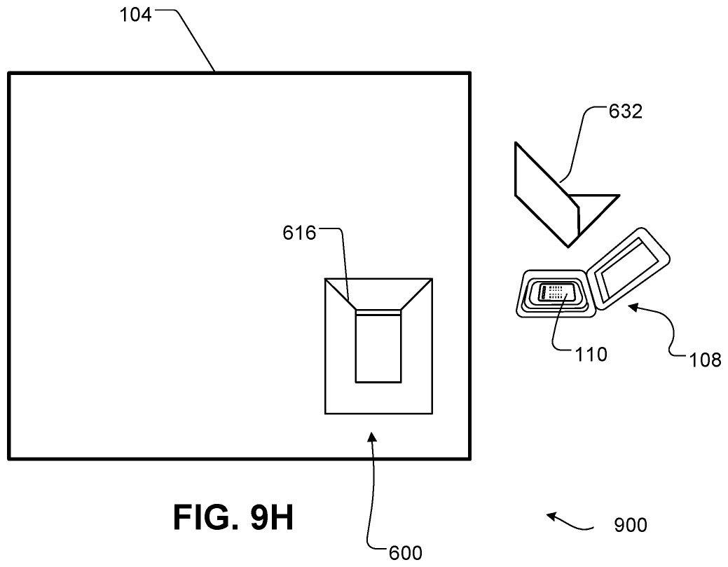

FIG. 9 visually shows the process 900 of assembling the reusable recyclable packing pouch 102, affixing the recyclable pouch 102 to the shipping package 104, and removing the plastic container 108 after shipping. In step A, the monitoring device 110 with the machine readable code 112 is placed in the first recessed region 220 inside the first shaped region 208 of the first portion 202 of the plastic container 108. The second portion 204 extends from the hinge 206. In step B, the second portion 204 is snapped shut on the first portion 202 of the plastic container 108. The monitoring device 110 is securely held and protected within the shut plastic container 108. In step C, the plastic container 108 containing the monitoring device 110 is aligned to be placed in the paperboard jacket assembly 600. In step D, the plastic container 108 containing the monitoring device 110 is placed in the paperboard jacket assembly 600.

In step E, the paperboard jacket assembly 600 containing the plastic container 108 with the monitoring device 110 is placed with the first surface 112 (now not shown) down (or away from the person) with the full release liner 630 showing. In step F, the release liner 630 is removed from the paperboard jacket assembly 600 to show the second surface 628 of the adhesive coating 622. In step G, the paperboard jacket assembly 600 containing the plastic container 108 and the monitoring device 110 with the second surface 628 of the adhesive coating 622 toward the shipping envelope is affixed onto the shipping package 104. The shipping package 104 is shipped.

After the shipping package 104 has arrived at its final destination, as shown in step H, the perforations 616 are torn and the removing the perforated tab section 632 is removed, exposing a portion of the plastic container 108. The plastic container 108 is removed from the paperboard jacket assembly 600. The paperboard jacket assembly remains on the shipping package 104. The first portion 202 is separated from the second portion 204. The monitoring device 110 can be removed from the plastic container 108 and be reprogramed or reused. The plastic container 108 can be reused multiple times. If damaged beyond use, the plastic container 108 can be recycled. The shipping package 104 with the affixed but torn open paperboard jacket assembly 600 can be recycled.

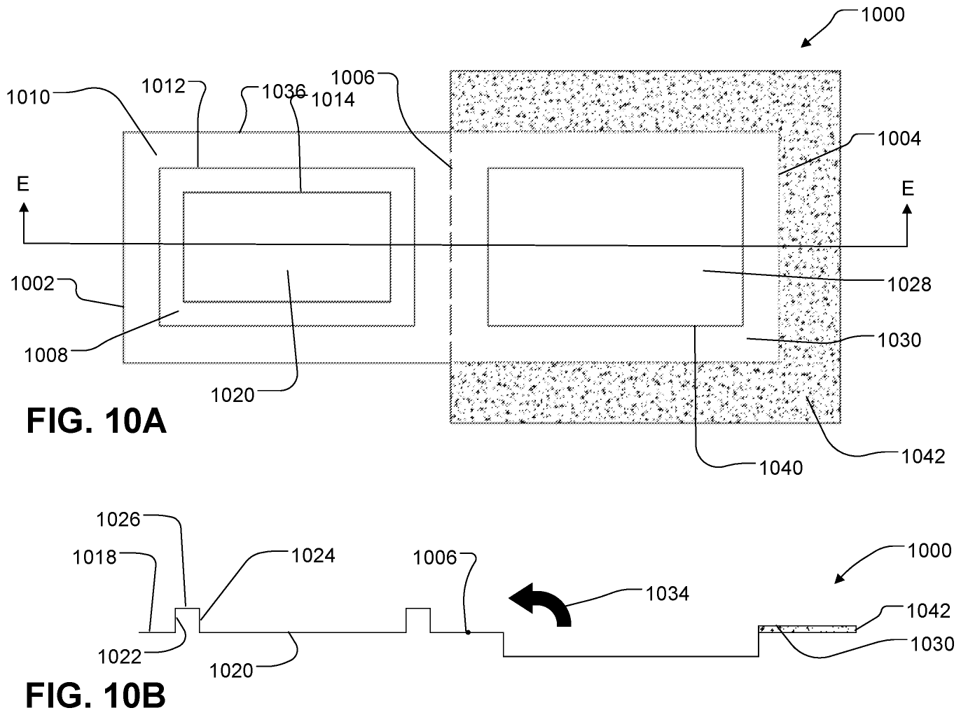

FIG. 10A is a top view of an another example recyclable packing pouch 1000. FIG. 10B is a cross-section view of the recyclable packing pouch 1000 of FIG. 10A with the recyclable packing pouch 1000 open along cross section E-E. The recyclable packing pouch 1000 affixes to the outside of a unit load device (ULD) or a reusable returnable container without a paperboard jacket previously discussed. Some examples of ULD's include internal stability units (ISU). Some examples of reusable returnable containers are reusable/returnable plastic totes (for convenience stores, medical device makers, and hospitals) and reusable/returnable plastic corrugated containers (for repair companies). Other examples of reusable returnable containers include reusable/returnable transit cases (for field service professionals) and metal reinforced reusable/returnable transit cases (for the trade show industry). The recyclable packing pouch 1000 can hold a monitoring device 110 or shipping documents.

Referring to FIG. 10A-10B, recyclable packing pouch 1000 has a first portion 1002 and a second portion 1004. The first portion has a first shaped region 1008. The first shaped region 1008 can be rectangular, as shown in FIG. 10A. Alternatively, the first shaped region 1008 can be a different geometric shape as previously discussed referring to reusable recyclable packing pouch 1000. The first shaped region 1008 has a first flange 1010 that extends around a first perimeter 1012 of the first shaped region 1008. The first perimeter 1012 and a second perimeter 1014 define the first shaped region 1008. The first shaped region 1008 has a top surface 1026 different that the first surface 1018. The top surface 1018 and the first perimeter 1012, and the second perimeter 1014 define the first shaped region 1008.

FIG. 10B shows a cross section of the reusable recyclable packing pouch 1000 along cross section E-E. Referring to FIG. 10B, the first flange 1010 extends from the first perimeter 1012 to an outer perimeter 1036 of the reusable recyclable packing pouch 1000. The first shaped region 1008 has a first recessed region 1020 defined by the second perimeter 1014. The greater height of either an outer surface 1022 or an inner surface 1024 of the first flange 1010 defines the height of the first shaped region 1020. The outer surface 1022 and the inner surface 1024 are connected by the top surface 1026. The inner surface 1024 extends around the second perimeter 1014 to define a first recessed region 1020. The first recessed region 1020 is sized to hold the monitoring device 110 and/or a packing slip.

The reusable recyclable packing pouch 1000 has a second portion 1004 sized to mate with the first shaped region 1008. The second portion 1004 has a second recessed region 1028 extending from a second surface 1030 at a third perimeter 1040 such as to define a void 1032. The void 1032 can also be referred to as a space. The void 1032 is between facing surfaces: the first surface 1018 of the first portion 1002 and the second surface 1030 of the second portion 1004. The second portion 1004 has a second flange 1038 corresponding to the second surface 1030. The first portion 1002 and the second portion 1004 are placed together by mating the first flange 1010 and the second flange 1038 to form the void 1032. The void 1032 holds the monitoring device 110. The first portion 1002 and the second portion 1004 snap together to form the protective shell.

A hinge 1006 can connect the first portion 1002 and the second portion 1004. For example, when the first portion 1002 and the second portion 1004 are formed from a single piece of plastic, the hinge 1006 can be a weaker portion of the plastic allowing the first portion 1002 and the second portion 1004 to articulate about the hinge 1006. For example, the hinge 1006 can be a thinner portion of plastic as compared to the first portion 1002 and the second portion 1004. Alternatively, hinge 1006 can be a perforated portion of plastic between the first portion 1002 and the second portion 1004. Referring to FIG. 10B, the first portion 1002 and the second portion 1004 articulate about the hinge 1006 like a clam-shell in the direction of arrow 1034.

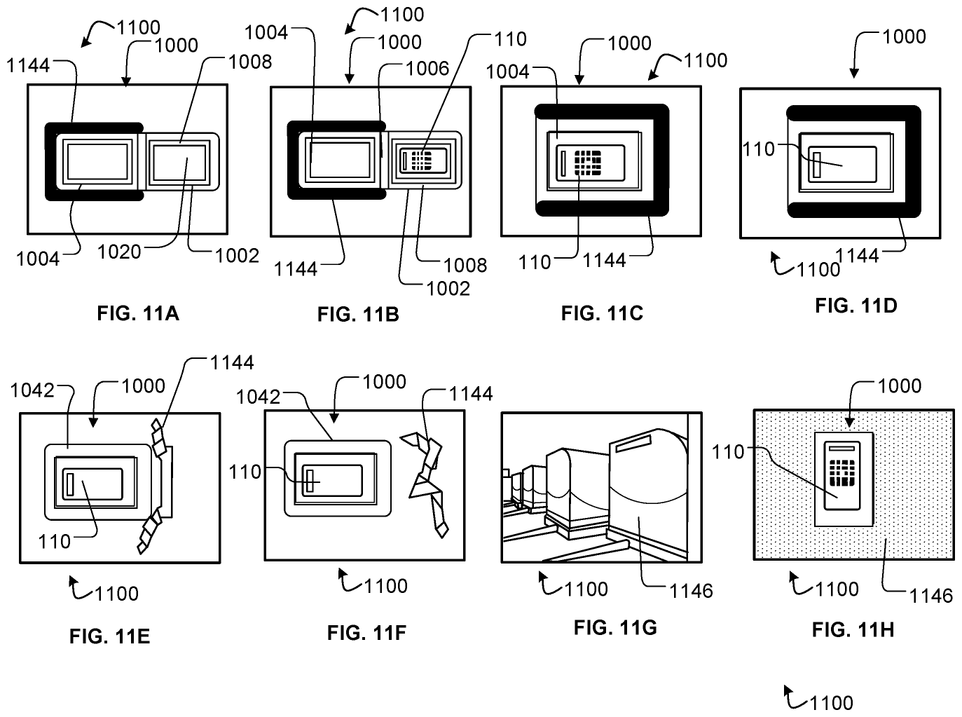

The reusable recyclable packing pouch 1000 has a third portion 1046 extending from the second portion 1004. The third portion 1046 can include a portion of the second surface 1030. An adhesive coating 1042 is applied to the third portion 1046. The adhesive coating 1042 is substantially similar to the adhesive coatings previously described. The reusable recyclable packing pouch 1000 includes a release liner 1144 (shown in FIG. 11), substantially similar to the release liners previously described. The adhesive coating 1042 attaches the reusable recyclable packing pouch 1000 to the ULD.

FIGS. 11A-H visually show the process 1100 of assembling the reusable recyclable packing pouch 1000 and affixing the reusable recyclable packing pouch 1000 to an ULD 1102. In step A, the reusable recyclable packing pouch 1000 is open to receive the monitoring device 110 in the first recessed region 1020. The release liner 1144 is toward the user. In step B, the monitoring device 110 with the machine readable code 112 is placed in the first recessed region 1020 inside the first shaped region 1008 of the first portion 1002 of the reusable recyclable packing pouch 1000. The second portion 1004 extends from the hinge 1006. In step C, the second portion 1004 is snapped shut on the first portion 1002 of the reusable recyclable packing pouch 1000. The monitoring device 110 is securely held and protected within the shut reusable recyclable packing pouch 1000. The release liner 1144 is away from the user. In step D, the reusable recyclable packing pouch 1000 is flipped so the release liner 1144 is toward the user. In step E, the release liner 1144 is partially removed from the reusable recyclable packing pouch 1000, partially exposing the adhesive coating 1042. In step F, the release liner 1144 is fully removed from the reusable recyclable packing pouch 1000, fully exposing the adhesive coating 1042. In step G, an ULD 1146 is identified to which the reusable recyclable packing pouch 1000 containing the monitoring device 110 will be affixed.

In step H, the reusable recyclable packing pouch 1000 is affixed to the ULD 1146 by the adhesive coating 1042. The ULD 1146 is shipped. After the ULD 1146 has arrived at its final destination, as shown in step H, the reusable recyclable packing pouch 1000 and the monitoring device 110 will be kept attached on the ULD 1146 for continued monitoring at the location and movement of the ULD 1146 within the distribution channel.

In some cases, the ULD 1146 is shipped to intermediate destinations. When shipped to intermediate destinations, the reusable recyclable packing pouch 1000 and the monitoring device 110 stay attached to the ULD 1146 for continued monitoring and tracking of the ULD 1146 within the multiple distribution channels and shipping networks between multiple locations.

In some cases, the ULD 1146, with the reusable recyclable packing pouch 1000 and the monitoring device 110, is shipped to the final destination at a customer location. The reusable recyclable packing pouch 1000 and the monitoring device 110 remains attached to the ULD 1146 at the customer location. An operator of the distribution channel can deactivate the monitoring device. Later, the operator of the distribution channel can retrieve the ULD 1146 with the reusable recyclable packing pouch 1000 and the deactivated monitoring device 110. The operator can then reactivate the monitoring device 110 for further use in the distribution channel.

Further, in cases where the reusable recyclable packing pouch 1000 is used to attach monitoring device 110 on the surface of customer's reusable returnable package (not shown in the drawings), the reusable recyclable packing pouch 1000 with monitoring device 110 inside will be kept attached on the customer's package. An operator of the distribution channel can deactivate the monitoring device 110. The monitoring device 110 will be re-activated when the operator of the distribution channel picks up this customer's package for next shipment.

When either or both the reusable recyclable packing pouch 1000 and the monitoring device 110 attached on the ULD 1146 or the customer's reusable returnable package are damaged beyond use, the reusable recyclable packing pouch 1000 with monitoring device 110 inside is removed from the ULD 1146 or from the customer's reusable returnable package (not shown). The first portion 1002 of the reusable recyclable packing pouch 1000 is separated from the second portion 1004 reusable recyclable packing pouch 1000. The monitoring device 110 can be removed from the reusable recyclable packing pouch 1000 and be reprogramed or reused. A new double sided adhesive coating 1042 can be applied to the reusable recyclable packing pouch 1000. The reusable recyclable packing pouch 1000 can be reused multiple times. If damaged beyond use, the reusable recyclable packing pouch 1000 can be recycled.

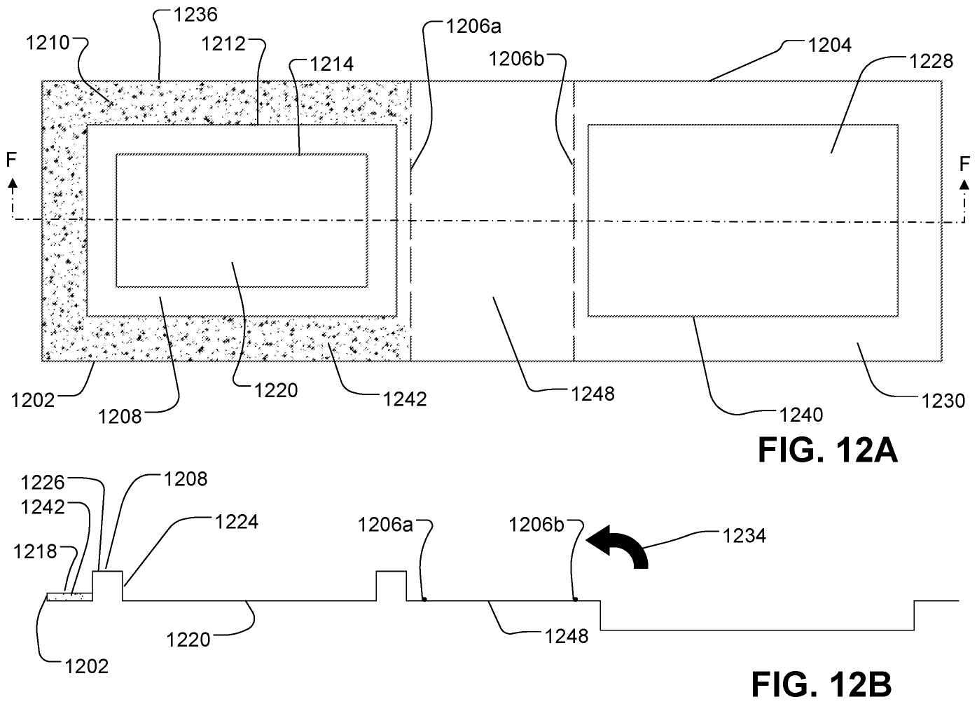

FIG. 12A is a top view of another reusable recyclable packing pouch of the reusable recyclable packing pouch for attaching to a rope. FIG. 12B is a cross-section view of the reusable recyclable packing pouch of FIG. 12A with the reusable recyclable packing pouch open along cross section F-F. Referring to FIG. 12A-12B, the reusable recyclable packing pouch 1200 has a first portion 1202 and a second portion 1204. The first portion has a first shaped region 1208. The first shaped region 1208 can be rectangular, as shown in FIG. 12A. Alternatively, the first shaped region 1208 can be a different geometric shape as previously discussed referring to reusable recyclable packing pouch 1200. The first shaped region 1208 has a first flange 1210 that extends around a first perimeter 1212 of the first shaped region 1208. The first perimeter 1212 and a second perimeter 1214 define the first shaped region 1208. The first shaped region 1208 has a top surface 1226 different that the first surface 1218. The top surface 1218 and the first perimeter 1212, and the second perimeter 1214 define the first shaped region 1208.

FIG. 12B shows a cross section of the reusable recyclable packing pouch 1200 along cross section F-F. Referring to FIG. 12B, the first flange 1210 extends from the first perimeter 1212 to an outer perimeter 1236 of the reusable recyclable packing pouch 1200. The first shaped region 1208 has a first recessed region 1220 defined by the second perimeter 1214. The greater height of either an outer surface 1222 or an inner surface 1224 of the first flange 1210 defines the height of the first shaped region 1220. The outer surface 1222 and the inner surface 1224 are connected by the top surface 1226. The inner surface 1224 extends around the second perimeter 1214 to define a first recessed region 1220. The first recessed region 1220 is sized to hold the monitoring device 110 and/or a packing slip.

The reusable recyclable packing pouch 1200 has a second portion 1204 sized to mate with the first shaped region 1208. The second portion 1204 has a second recessed region 1228 extending from a second surface 1230 at a third perimeter 1240 such as to define a void 1232. The void 1232 can also be referred to as a space. The void 1232 is between facing surfaces: the first surface 1218 of the first portion 1202 and the second surface 1230 of the second portion 1204. The second portion 1204 has a second flange 1238 corresponding to the second surface 1230. The first portion 1202 and the second portion 1204 are placed together by mating the first flange 1210 and the second flange 1238 to form the void 1232. The void 1232 holds the monitoring device 110. The first portion 1202 and the second portion 1204 snap together to form the protective shell.

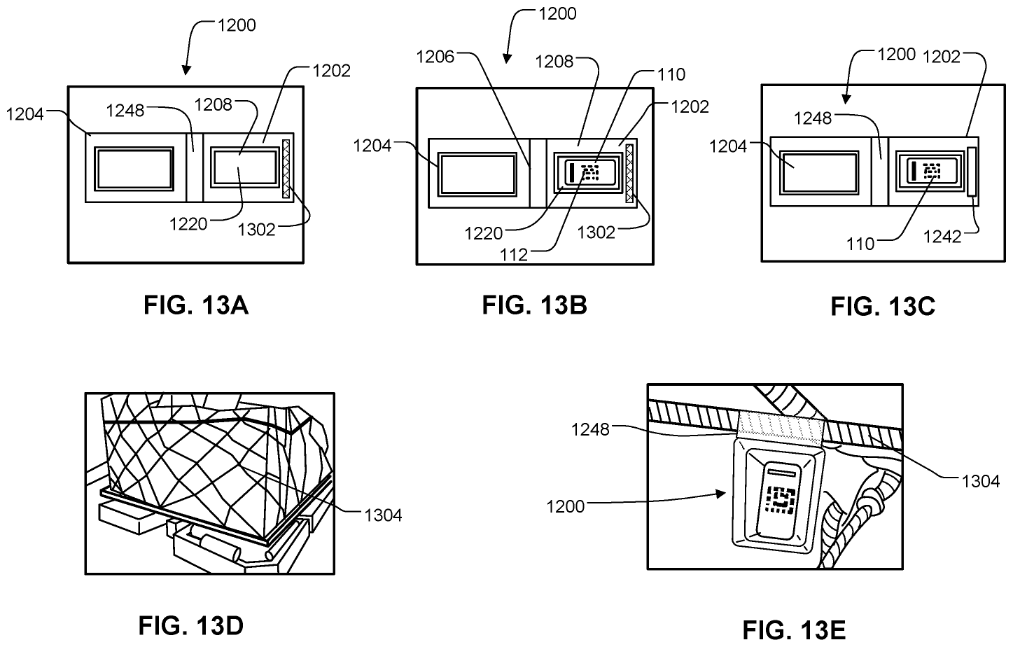

A first hinge 1206a can connect the first portion 1202 to a hinge portion 1248 to a second hinge 1206b and the second portion 1204. For example, when the first portion 1202 and the second portion 1204 are formed from a single piece of plastic, the first hinge 1206a and the second hinge 1206b can be a weaker portion of the plastic allowing the first portion 1202 and the second portion 1204 to articulate about the first hinge 1206a and the second hinge 1206b. For example, the first hinge 1206a and the second hinge 1206b can be a thinner portion of plastic as compared to the first portion 1202 and the second portion 1204. Alternatively, first hinge 1206a and the second hinge 1206b can be a perforated portion of plastic between the first portion 1202 and the second portion 1204. Referring to FIG. 12B, the first portion 1202 and the second portion 1204 articulate about the first hinge 1206a and the second hinge 1206b like a clam-shell in the direction of arrow 1234. The hinge portion 1248 wraps around a cylindrical object, a rope 1304 shown in FIG. 13D-13E to hold the reusable recyclable packing pouch 1200 in place. The rope 1304 can be part of a net. The net can surround or hold multiple shipping packages or containers. In some cases, the net holds multiple packages or containers on a shipping pallet. In some cases, the hinge portion 1248 can form an attachment loop around rope 1304.

The reusable recyclable packing pouch 1200 has an adhesive coating 1242 on the first flange 1210 from the first perimeter 1212 to the outer perimeter 1236. The adhesive coating 1242 can cover all of the first flange 1210 or a portion of the first flange 1210. The adhesive coating 1242 is substantially similar to the adhesive coatings previously described. The reusable recyclable packing pouch 1000 includes a release liner 1302 (shown in FIG. 13A-13C), substantially similar to the release liners previously described. The adhesive coating 1242 attaches the first portion 1202 of the reusable recyclable packing pouch 1200 to the second portion 1204 of the reusable recyclable packing pouch 1200 around the rope 1304.

FIGS. 13A-E illustrate steps of a method of assembling the reusable recyclable packing pouch of FIG. 12A. FIGS. 13A-E visually show the process 1300 of assembling the reusable recyclable packing pouch 1200 and affixing the reusable recyclable packing pouch 1100 to a rope 1304. In step A, the reusable recyclable packing pouch 1200 is open to receive the monitoring device 110 in the first recessed region 1220. The release liner 1302 is toward the user. In step B, the monitoring device 110 with the machine readable code 112 is placed in the first recessed region 1220 inside the first shaped region 1208 of the first portion 1202 of the reusable recyclable packing pouch 1200. The second portion 1204 extends from the hinge 1206. In step C, the release liner 1032 is removed from the first portion 1202 revealing the adhesive layer 1242. In step D, a rope 1304 is identified to which the reusable recyclable packing pouch 1200 containing the monitoring device 110 will be affixed. In this case, as shown in step D, the rope 1304 is part of a net holding packages on a pallet.

In step E, the reusable recyclable packing pouch 1200 is affixed to the rope 1304 by the adhesive coating 1242. The packages on the pallet with the reusable recyclable packing pouch 1200 and the monitoring device 110 are shipped. After the packages on the pallet have arrived at their final destination, the reusable recyclable packing pouch 1200 and the monitoring device 110 will be kept attached on the rope 1304 of the net for continued monitoring of the packages on the pallet at the location and movement of the rope 1304 of the net within the distribution channel.

In some cases, the rope 1304 of net holding packages on the pallet is shipped to intermediate destinations. When shipped to intermediate destinations, the reusable recyclable packing pouch 1200 and the monitoring device 110 stay attached to the rope 1304 of net holding packages on the pallet for continued monitoring and tracking of the rope 1304 of net holding packages on the pallet within the multiple distribution channels and shipping networks between multiple locations.

In some cases, the rope 1304 of net holding packages on the pallet, with the reusable recyclable packing pouch 1200 and the monitoring device 110, is shipped to the final destination at a customer location. The reusable recyclable packing pouch 1000 and the monitoring device 110 remains attached to the rope 1304 of net holding packages on the pallet at the customer location. An operator of the distribution channel can deactivate the monitoring device. Later, the operator of the distribution channel can retrieve the rope 1304 of net holding packages on the pallet with the reusable recyclable packing pouch 1200 and the deactivated monitoring device 110. The operator can then reactivate the monitoring device 110 for further use in the distribution channel.

Further, in cases where the reusable recyclable packing pouch 1200 is used to attach monitoring device 110 on a handle (not shown) of the customer's reusable returnable package, the reusable recyclable packing pouch 1200 with monitoring device 110 inside will be kept attached on the customer's package. An operator of the distribution channel can deactivate the monitoring device 110. The monitoring device 110 will be re-activated when the operator of the distribution channel picks up this customer's package for next shipment.

When either or both the reusable recyclable packing pouch 1200 and the monitoring device 110 are attached on the rope 1304 of the net or the customer's reusable returnable package are damaged beyond use, the reusable recyclable packing pouch 1200 with monitoring device 110 inside is removed from the net 1304 or from the customer's reusable returnable package (not shown). The first portion 1202 of the reusable recyclable packing pouch 1200 is separated from the second portion 1204 reusable recyclable packing pouch 1200. The monitoring device 110 can be removed from the reusable recyclable packing pouch 1200 and be reprogramed or reused. A new double sided adhesive coating 1242 can be applied to the reusable recyclable packing pouch 1200. The reusable recyclable packing pouch 1200 can be reused multiple times. If damaged beyond use, the reusable recyclable packing pouch 1200 can be recycled.

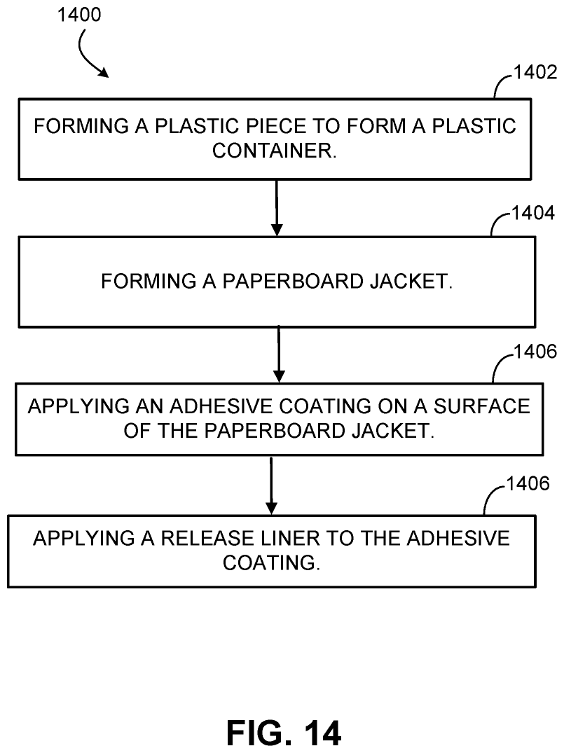

FIG. 14 shows an example method 1400 of manufacturing the reusable recyclable packing pouch. At 1402, a plastic container is formed from a plastic piece. The plastic container includes a first portion and a second portion. The first portion has a shaped region with a flange extending around a perimeter of the shaped region. The second portion sized to mate with the flange such as to define a space between facing surfaces of the second portion and the shaped region of the first portion. The shaped region can be formed to contain shipping documents. The plastic piece can be thermally pressed to form the plastic container. The shaped region can be formed to accommodate a tracking sensor within the space defined between the facing surfaces of the second portion and the shaped region of the first portion. A monitoring device can be attached to the plastic container. The monitoring device can sense a condition of the reusable recyclable packing pouch.

At 1404, a paperboard jacket is formed. The paperboard jacket includes an aperture defined therethrough. The aperture is sized to permit the shaped region of the plastic container to pass through while the flange extends past edges of aperture and overlaps with a region of paperboard jacket at a periphery of the aperture. A transparent window can be fixed to the aperture and onto the paperboard jacket to allow a visual sensor to sense a condition within the paperboard jacket. The condition can be an image. The method can include sensing the condition through the transparent window. A front surface of the paperboard jacket can be perforated. Perforating the front surface of the paperboard jacket makes the front surface of the paperboard jacket able to be torn to open the paperboard jacket and remove contents.

At 1406, an adhesive coating is applied on a surface of the paperboard jacket. Applying the adhesive coating can include sealing the paperboard jacket shut by the adhesive coating.

At 1408, a release liner is attach to an exterior surface of a back sheet via the adhesive coating such that the release liner is removable.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub-combination.

While this document contains many specific implementation details, these should not be construed as limitations on the scope of what may be claimed, but rather as descriptions of features that may be specific to particular implementations or embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

1. A reusable recyclable packing pouch comprising:
a plastic container comprising:
first portion with a shaped region having a flange extending around a perimeter of the shaped region, and
a second portion sized to mate with the flange such as to define a space between facing surfaces of the second portion and the shaped region of the first portion;
a paperboard jacket comprising an aperture defined therethrough, wherein the aperture is sized to permit the shaped region of the plastic container to pass through while the flange extends past edges of aperture and overlaps with a region of paperboard jacket at a periphery of the aperture; and
an adhesive coating located on a surface of the paperboard jacket.

2. The reusable recyclable packing pouch of claim 1, wherein the plastic container further comprises a transparent portion.

3. The reusable recyclable packing pouch of claim 2, wherein the transparent portion permits scanning of a machine readable code contained within the plastic container.

4. The reusable recyclable packing pouch of claim 3, wherein the machine readable code contains information regarding a content of the reusable recyclable packing pouch.

5. The reusable recyclable packing pouch of claim 1, further comprising a monitoring device configured to sense a condition of a package to which the reusable recyclable packing pouch is attached.

6. The reusable recyclable packing pouch of claim 5, wherein the condition of the package comprises one or more of: a location of the package, an orientation of the package, or a handling history of the package.

7. The reusable recyclable packing pouch of claim 1, wherein the paperboard jacket has perforations extending from the edge of the aperture to an outer edge of the paperboard jacket.

8. The reusable recyclable packing pouch of claim 1, wherein the shaped region is sized to contain shipping documents.

9. The reusable recyclable packing pouch of claim 1, wherein the shaped region is configured to accommodate a tracking sensor within the space defined between the facing surfaces of the of the second portion and the shaped region of the first portion.

10. The reusable recyclable packing pouch of claim 1, wherein the adhesive coating is located within a second region of the paperboard jacket that does not overlap with the region of paperboard jacket at a periphery of the aperture.

11. The reusable recyclable packing pouch of claim 1, wherein the plastic container is polyethylene terephthalate.

12. The reusable recyclable packing pouch of claim 1, wherein the plastic container comprises a recyclable plastic material.

13. A shipping container with a reusable recyclable packing pouch, the shipping container comprising:
a plastic container positioned on a surface of the shipping container, the plastic container comprising:
first portion with a shaped region having a flange extending around a perimeter of the shaped region, and
a second portion mated with the flange to define a space between facing surfaces of the second portion and the shaped region of the first portion; and
a paperboard jacket adhered to the surface of the shipping container, the paperboard jacket comprising an aperture defined therethrough, wherein the shaped region of the plastic container extends through the aperture while the paperboard jacket overlaps the flange of the plastic container so as to retain the plastic container in place on the surface of the shipping container.

14. The reusable recyclable packing pouch of claim 13, wherein the plastic container further comprises a transparent portion.

15. A method of making a reusable recyclable packing pouch, the method comprising:
forming a plastic piece to form a plastic container comprising:
first portion with a shaped region having a flange extending around a perimeter of the shaped region, and
a second portion sized to mate with the flange such as to define a space between facing surfaces of the second portion and the shaped region of the first portion;
forming a paperboard jacket, the paperboard jacket comprising an aperture defined therethrough, wherein the aperture is sized to permit the shaped region of the plastic container to pass through while the flange extends past edges of aperture and overlaps with a region of paperboard jacket at a periphery of the aperture; and
applying an adhesive coating on a surface of the paperboard jacket.

16. The method of claim 15, further comprising thermally pressing the plastic piece to form the plastic container.

17. The method of claim 15, further comprising sealing the paperboard jacket shut by the adhesive coating.

18. The method of claim 15, further comprising fixing a transparent window configured to allow a visual sensor to sense a condition within the paperboard jacket on the paperboard jacket.

19. The method of claim 15, further comprising perforating a front surface of the paperboard jacket, wherein perforating the front surface of the paperboard jacket configures the front surface of the paperboard jacket to be torn to open the paperboard jacket and remove contents.

20. The method of claim 15, further comprising forming the shaped region to accommodate a monitoring sensor within the space defined between the facing surfaces of the second portion and the shaped region of the first portion.

21. The method of claim 15, further comprising attaching a release liner to an exterior surface of a back sheet via the adhesive coating such that the release liner is removable.
